(19) United States
(12) Patent Application Publication
(10) Pub. No.: US 2006/0249662 A1
(43) Pub. Date: Nov. 9, 2006

(54) Decorative, light-sensitive, vibration-activated personal safety beacon

(76) Inventor: Heidi Lynn Turner, Newport Beach, CA (US)

Correspondence Address: Heidi Turner, 1323 East Balboa Blvd., #2, Newport Beach, CA, 92661, US

(21) Appl. No.: 11/122,497

(22) Filed: May 4, 2005

(51) Int. Cl. G06M 7/00

(52) U.S. Cl. 250/221

(57) ABSTRACT

An electronic zipper-pull personal safety beacon that is light-sensitive and vibration-activated which includes a decorative housing (22) for the support of: a power source (1) and an electronic circuit (21) further comprising; a printed circuit board, a photoconductive cell (2), a vibration detector (3), and a timer (5) to enable at least one self-flashing light emitting diode (6) for a predetermined period of time.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to a decorative zipper-pull accessory, specifically an illumination safety beacon that is light-sensitive and vibration-activated for aesthetics, entertainment and safety.

2. Prior Art

The use of a decorative zipper-pull to facilitate the opening and closing of a zipper is well known. While zippers are worn everyday by most people, zipper-pulls are limited to having aesthetic appeal and are not utilized to provide personal safety. Previous attempts to provide safety devices that are both light sensitive and motion activated have been made in the past. See for example U.S. Pat. No. 5,523,927 to Gokey. The Gokey device pertains to an illuminated pet collar. While Gokey suggests the collar of the invention would find general use for people engaged in motion activities in dark conditions as well, I have a hard time imaging children wearing a safety collar. Another example is U.S. Pat. No. 6,175,196 to Ragner et al. The Ragner device pertains to illuminated rotating assemblies, such as skate wheels, where the entire assembly is permanently sealed in a housing. This does not provide a method of power source replacement which shortens the effective life of the safety light. It also provides a very useful safety beacon, but only when one is using an item containing a rotating assembly.

U.S. Pat. No. 6,012,822 to Robinson, and U.S. Pat. No. 5,866,987 to Wut pertain to footwear. While Robinson also encompasses wearing apparel it does not provide a method for automatic shut off during daylight hours, which contributes to shortened power source life and a non-operational safety light at times of need. The Wut device does contain both a vibration and light sensitive switch, but footwear in itself limits the effectiveness of the invention as a safety device. Feet, and the shoes that cover them, are generally close to the ground as are curbs, vegetation, and other items which can block the safety light from view and create a potentially dangerous situation. Also, humans tend to move forward whereas the heel light from a shoe is directed behind the wearer. This tends to minimize heel lights as an effective safety beacon.

Personal illuminated safety devices also exist but are generally expensive, large, and cumbersome. None are made and marketed directly for small children, who could greatly benefit from such a safety beacon. For example U.S. Pat. No. 5,856,727 to Schroeder et al. claims a similar device that is both vibration and light sensitive. The circuit however, is much more complicated indicating a device that is larger and more expensive.

Many of these devices will function at all times if accidentally left on, resulting in a dead power source when the device is needed the most. It is unlikely that such systems will be used properly by children. Either the light is not turned on at dusk or when they are turned-on, the light is not turned-off, thus draining the power source. For example U.S. Pat. No. 6,611,244 to Guritz pertains to an ornamental illuminated jewelry or apparel attachment. It does not provide a vibration or light sensitive switch and must be turned on and off.

An individual must also remember to wear or attach these devices and have advance knowledge of when they will be in a dark and potentially dangerous place or situation. For example U.S. Pat. No. 6,682,202 to Wong and U.S. Pat. No. 5,709,464 to Tseng. Neither device provides an automatic shut-off during daylight hours when the safety signal would be difficult to see and therefore unnecessary. They would require either an on/off switch or the wearer to selectively attach the item when a need is anticipated.

Iron-on or stitched-on reflectors can be permanently applied to clothing or accessories but these are dependent on external light sources and will not effectively produce their intended warning if light does not strike the reflector directly. For example, bicyclists or the driver of an automobile often can't see pedestrians on darkened streets or paths.

### OBJECTS AND ADVANTAGES

The present invention is quite compact and can be attached, semi-permanently, to clothing, via a zipper-pull which is difficult for children to remove. It is often cold outside during low light situations and a jacket or coat would often be worn at these times. A safety beacon attached to clothing, (such as a jacket, coat, or purse) in this manner, allows the wearer to have the beacon at their disposal whenever the clothing is worn. The present invention will automatically turn on whenever it is needed. The present invention is especially useful in protecting small children who may forget to wear, forget to turn on, or remove a more cumbersome safety device. It can also help adults to visually track their children in crowded low-light settings.

The electronic circuit of the present invention is quite simple and inexpensive to produce. It does not require an external light source and only becomes functional when it is dark and the wearer is in motion. This conserves power and provides a safety beacon conveniently available at the time it is most needed. Further objects and advantages of my invention will become apparent from a consideration of the drawings and ensuing description.

### SUMMARY

The present invention, as claimed, is a decorative electronic fashion accessory. It is intended as an entertaining and attractive addition to wearing apparel and accessories that also functions as a convenient safety beacon to provide increased visibility in low light situations. It can be semi-permanently attached to the head of a zipper and left on at all times to function automatically when the wearer finds themselves in low light situations.

In accordance with the preferred embodiment of the present invention, when the vibration sensor detects motion, a brief electrical pulse is passed to the circuit. The short pulse passes through a voltage divider utilizing a photoconductive cell. When the cell is exposed to ambient light, it causes the safety beacon to remain in the off state. When the cell is deprived of ambient light, the vibration sensor can activate the circuit and allow the self-flashing light emitting diode(s) to flash for a predetermined period of time. As the photoconductive cell is only exposed to a brief pulse in response to motion, the resistive circuit dissipates very little power during daylight hours.

In accordance with the preferred embodiment of the present invention, the safety beacon only functions when it is in motion and operating in low or a complete absence of light. This allows for a greatly extended life for the power source.

### DRAWINGS—FIGURES

Drawings and a detailed description of a specific embodiment of the invention is described below:

FIG. 1 is a block diagram of an exemplary embodiment of a light-sensitive, vibration-activated safety beacon constructed in accordance with the present invention.

FIG. 2 shows a wiring diagram of the electronic circuit.

FIG. 3 shows a wiring diagram of the alternate limited power electronic circuit.

FIG. 4 is a front view of a perspective embodiment of the light-sensitive, vibration-activated safety beacon constructed in accordance with the present invention.

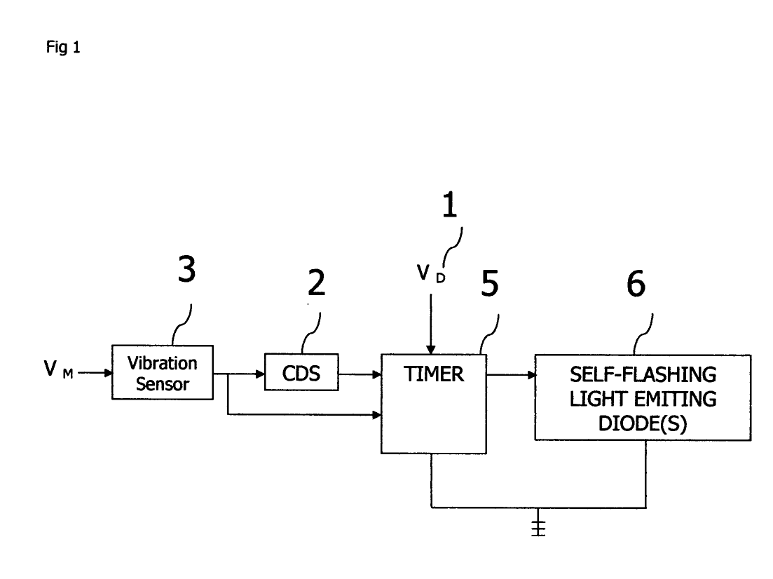

### DETAILED DESCRIPTION—FIGS. 1-4—PREFERRED EMBODIMENT

A light-sensitive, vibration-activated, safety beacon constructed in accordance with the present invention is illustrated in FIGS. 1-4.

Referring to the accompanying drawings, FIG. 1 illustrates the light-sensitive, vibration-activated electronic safety beacon comprising generally a system power source 1, a vibration sensor 3, a photoconductive cell (CDS) 2, a timer component 5, and a self-flashing light emitting diode(s) component 6. The system power source 1 provides power V_{D} to the timing component 5. Vibration of the circuit will cause the vibration sensor 3 to pass a voltage pulse V_{M} towards the CDS 2. In the absence of ambient light the CDS 2 will allow the voltage pulse V_{M} to pass and activate the trigger input of the timing component 5. This in turn activates the diode(s) 6 for a predetermined period of time.

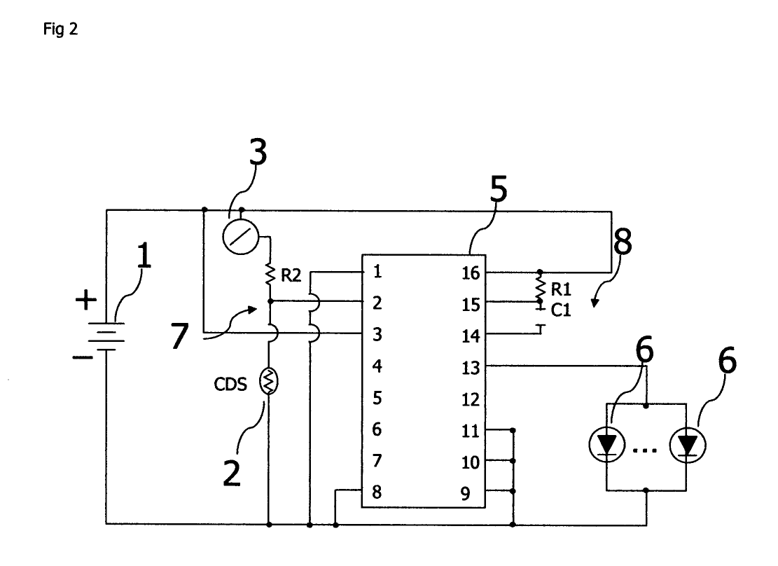

FIG. 2 illustrates the light-sensitive, vibration-activated, electronic safety beacon circuitry. The integrated circuit 5 is a retriggerable monostable multivibrator (CD74HC123) manufactured by Texas Instruments. In operation with the vibration sensitive switch 3 stationary/open, the integrated circuit 5 will be in a hold mode. A timing capacitor C1 will be charged through a timing resistor R1 to the voltage value of the power source 1. The timing capacitor C1 and timing resistor R1 make up a timing circuit 8 which determines the duration of the output at pin 13. Pin 1 of the integrated circuit 5 is held low while pin 3 is held high to the voltage of the power source 1. Pin 2 acts as the trigger input and it is held low while the vibration sensitive switch 3 is stationary. While the integrated circuit 5 remains in the hold mode, the output at pin 13 will remain at 0 volts which maintains the diode(s) 6 in an OFF state. The circuit will remain in the OFF state until motion causes the vibration sensitive switch 3 to close. A voltage divider circuit 7, created by a resistor R2 and the CDS 2, determines the voltage that will arrive at the trigger input of pin 2. The CDS 2 has a very low resistance in the presence of ambient light. This will cause the voltage pulse to be dissipated in the resistor R2 and not activate the integrated circuit 5. The CDS 2 has a very high resistance in the absence of ambient light, which allows the voltage pulse from the closed vibration sensor 3 to reach pin 2 of the integrated circuit 5. At this point, pin 2 of the integrated circuit 5 receives the short voltage pulse from the power source 1. This activates the integrated circuit 5 and causes a voltage to conduct at the output pin 13. This momentarily illuminates the diode(s) 6 for the predetermined duration determined by the timing circuit 8. During this flashing period, the diode(s) 6 may continue to be actuated by a new trigger input at pin 2, which will start a new flashing period by interrupting the previous one. After a predetermined ON state where there is no additional trigger input at pin 2, the circuit is returned to its reset condition where it awaits another valid trigger from low to high at pin 2.

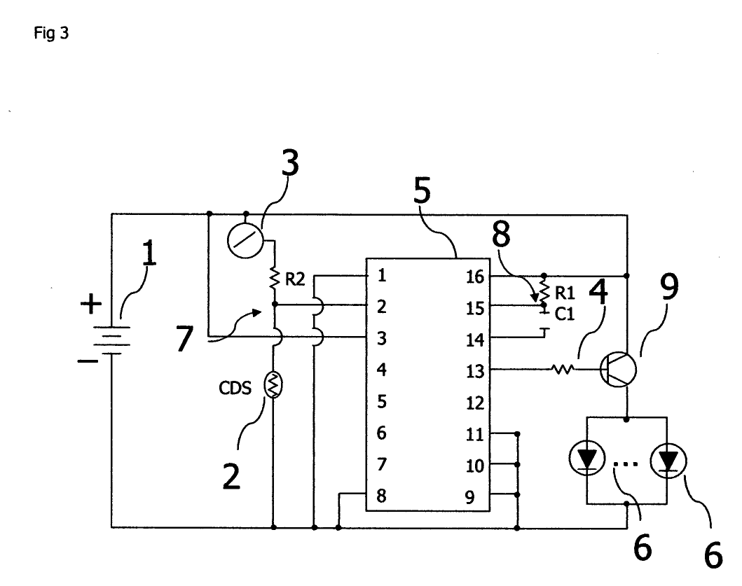

FIG. 3 is a duplicate of FIG. 2 with the addition of an output resistor 4 and a transistor 9. These optional additions are made to the circuit when it is necessary to save space by providing a very small battery voltage as a power source 1. In this instance, the output at pin 13 can be too low a voltage to power the light emitting diode(s) when the circuit is in the ON state. The output resistor 4 can modulate the output voltage to the transistor 9. This will cause the transistor 9 to conduct and allow additional power from the limited power source 1 to illuminate the diode(s) 6.

The circuitry shown in FIG. 2 and FIG. 3 will only momentarily illuminate the diode(s) 6 in darkness with the vibration sensitive switch 3 closure. Many types of vibration sensors 3 on the market will allow the electronic safety beacon of the present invention to be kept in any position while motionless. Also, the small trigger pulse that is dissipated by the resistor R2 saves power by prohibiting the operation of the device in daylight hours. Thus, the life of the power source 1 will be greatly extended.

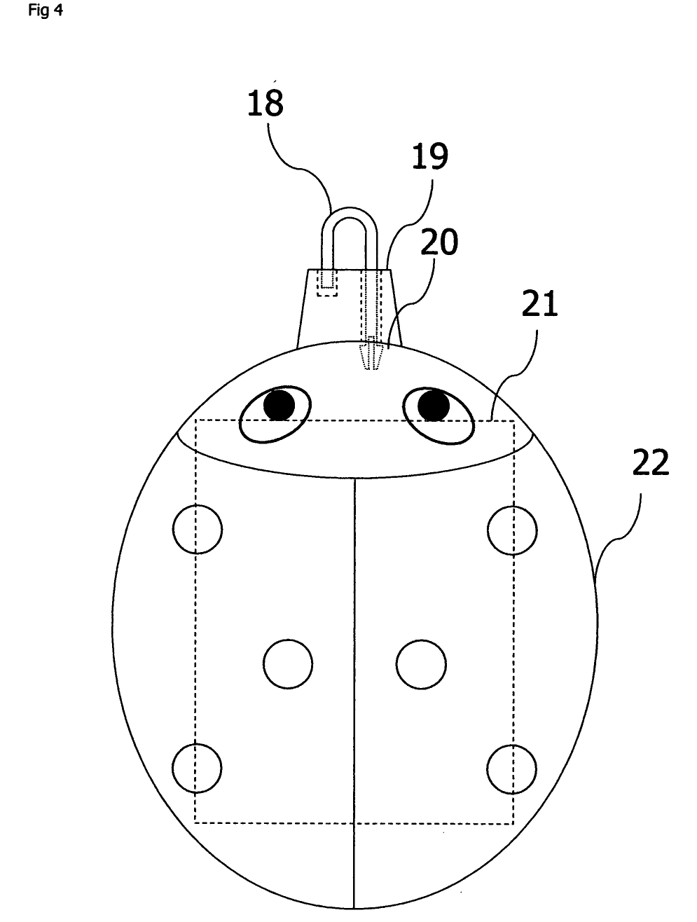

FIG. 4 illustrates a front view of a perspective embodiment of the light-sensitive, vibration-activated safety beacon. A zipper-pull attachment 18 forms a loop at the top which can be used to attach the device to a zipper head (not pictured). An electronic circuit 21 is mounted within the cavity of a transparent decorative housing 22 and visible light produced from, and received by, the enclosed circuit 21 passes through the housing 22. The housing 22 includes an extended piece that acts as a support 19 for the zipper-pull attachment 18. The zipper-pull attachment 18 is made of a rigid material and fits loosely into the two holes of the support 19. At least one of the two holes in the support 19 is cut completely through to the inside of the housing 22. This allows for one end of the zipper-pull attachment 18 to extend into the cavity of the housing 22. That end of the zipper-pull attachment 18 has extending tabs 20 that will not allow the zipper-pull attachment 18 to be removed from the exterior of the housing 22. The only way to remove the zipper-pull attachment 18 is to compress the tabs 20 from the interior of the housing 22. This makes it impossible for small children to remove the device when the cavity of the housing 22 is sealed.

### CONCLUSION, RAMIFICATIONS, AND SCOPE

Thus the reader will see that the safety beacon of the invention provides a highly reliable, small, lightweight, and economical electronic safety device. It is attached to clothing in a semi-permanent manner as a zipper-pull, making it difficult for children to remove. It can be used by children of all ages to improve their personal safety in unexpected low light situations. While the above description contains many specificities, these should not be construed as limitations on the scope of the invention, but rather as an exemplification of one preferred embodiment thereof. Many other variations are possible. For example the decorative housing is intended to have aesthetic appeal and could be designed in an unlimited number of materials, shapes, colors, and sizes. Also, the circuit can be made in integrated form or as an application specific integrated circuit. Accordingly, the scope of the invention should be determined not by the embodiment illustrated, but by the appended claims and their legal equivalents.

I claim:

1. A light-sensitive, vibration-activated electronic safety beacon, comprising:
(a) a decorative housing;
(b) a zipper-pull attachment mechanism;
(c) an electronic circuit mounted to said housing, said circuit comprising:
i. a light sensor for sensing the existence of ambient light;
ii. a vibration sensor for sensing the presence of motion;
iii. at least one self-flashing light emitting diode; and
iv. a timer enabling the operation of at least one said self-flashing light emitting diode for a predetermined period of time; and
(d) a system power source mounted within said housing.

2. The light-sensitive, vibration-activated electronic safety beacon of claim 1, wherein said decorative housing comprises a transparent portion permitting light to pass through.

3. The light-sensitive, vibration-activated electronic safety beacon of claim 1, wherein said decorative housing further comprises multiple pieces.

4. The light-sensitive, vibration-activated electronic safety beacon of claim 3, wherein said decorative housing further comprises a gasket to produce a watertight seal.

5. The light-sensitive, vibration-activated electronic safety beacon of claim 1, wherein said electronic circuit further comprises a transistor providing rerouted power to at least one said self-flashing light emitting diode.

6. The light-sensitive, vibration-activated electronic safety beacon of claim 1, wherein said system power source is mounted within said circuit.

7. The light-sensitive, vibration-activated electronic safety beacon of claim 1, wherein said vibration sensor is mounted within said decorative housing.
